(19) United States
(12) Patent Application Publication
(10) Pub. No.: US 2018/0025505 A1
(43) Pub. Date: Jan. 25, 2018

(54) Image Processing Device, and related Depth Estimation System and Depth Estimation Method

(71) Applicant: MEDIATEK INC., Hsin-Chu (TW)

(72) Inventors: Yu-Hao Huang, Kaohsiung City (TW); Tsu-Ming Liu, Hsinchu City (TW)

(21) Appl. No.: 15/408,373

(22) Filed: Jan. 17, 2017

Related U.S. Application Data
(60) Provisional application No. 62/364,905, filed on Jul. 21, 2016.

(51) Int. Cl. G06T 7/55; H04N 13/02; H04N 5/225; G06T 7/11

(52) U.S. Cl. CPC G06T 7/55; G06T 7/11; H04N 13/0207; H04N 13/0271; H04N 5/2259; G06T 2207/20021; H04N 2013/0081

(57) ABSTRACT

An image processing device is applied to an image processing device and a related depth estimation system. The image processing device includes a receiving unit and a processing unit. The receiving unit is adapted to receive a capturing image. The processing unit is electrically connected with the receiving unit to determine a first sub-image and a second sub-image on the capturing image, to compute relationship between a feature of the first sub-image and a corresponding feature of the second sub-image, and to compute a depth map about the capturing image via disparity of the foresaid relationship. The feature of the first sub-image is correlated with the corresponding feature of the second sub-image, and a scene of the first sub-image is at least partly overlapped with a scene of the second sub-image.

### CROSS REFERENCE TO RELATED APPLICATIONS

This application claims the benefit of U.S. provisional application No. 62/364,905, filed on Jul. 21, 2016. The disclosures of the prior application are incorporated herein by reference herein in their entirety.

### BACKGROUND

The present invention relates to an image processing device and a related depth estimation system and a related depth estimation method, and more particularly, to an image processing device capable of computing a depth map by the single capturing image generated by the individual image capturing unit, and a related depth estimation system and a related depth estimation method.

With the advanced technology, the depth estimation technique is widespread applied to the consumer electronic device for environmental detection; for example, the mobile device may have depth estimation function to detect a distance of the landmark by specific application program, the camera may have the depth estimation function to draw the topographic map while the said camera is disposed on the drone or the vehicle. The conventional depth estimation technique utilizes two image sensors respectively disposed on different positions and driven to capture images about a tested object by dissimilar angles of vision. Disparity between the imaged is computed to form a depth map. However, the conventional mobile device and the conventional camera on the drone have limited camera interface, and have no sufficient space to accommodate the two image sensors; product cost of the said mobile device or the said camera with the two image sensors is expensive accordingly.

Another conventional depth estimation technique has an optical sensor disposed on a moving platform (such as the drone and the vehicle), the optical sensor captures a first image about the tested object at first time point, then the same optical sensor is shifted by the moving platform to capture a second image about the tested object at second time point. The known distance, and vision angles of the tested object respectively on the first image and the second image are utilized to compute displacement and rotation of the tested object relative to the optical sensor, and the depth map can be computed accordingly. The said conventional depth estimation technique is inconvenient for the drone and the vehicle because the optical sensor cannot accurately compute position parameter of the tested object located upon a rectilinear motion track of the drone and the vehicle.

Further, the conventional active light source depth estimation technique utilizes an active light source to output a detective signal to project onto the tested object, and then receives a reflected signal from the tested object to compute the position parameter of the tested object by analyzing the detective signal and the reflected signal. The conventional active light source depth estimation technique has expensive usage cost with large power consumption. Besides, the conventional stereo camera drives two image sensors to respectively capture images with different angles of vision, the two image sensors require high precision in automatic exposure, automatic white balance and time synchronization, so that the conventional stereo camera has drawbacks of expensive manufacturing cost and complicated operation.

### SUMMARY

The present invention provides an image processing device capable of computing a depth map by the single capturing image generated by the individual image capturing unit, and a related depth estimation system and a related depth estimation method for solving above drawbacks.

According to at least one claimed invention, an image processing device includes a receiving unit and a processing unit. The receiving unit is adapted to receive a capturing image. The processing unit is electrically connected with the receiving unit to determine a first sub-image and a second sub-image on the capturing image, to compute relationship between a feature of the first sub-image and a corresponding feature of the second sub-image, and to compute a depth map about the capturing image via disparity of the foresaid relationship. The feature of the first sub-image is correlated with the corresponding feature of the second sub-image, and a scene of the first sub-image is at least partly overlapped with a scene of the second sub-image.

According to at least one claimed invention, a depth estimation system includes at least one virtual image generating unit, an image capturing unit and an image processing device. The virtual image generating unit is set on a location facing a detective direction of the depth estimation system. The image capturing unit is disposed by the virtual image generating unit and has a wide visual field function. The image capturing unit generates a capturing image containing the virtual image generating unit via the wide visual field function. The image processing device is electrically connected to the image capturing unit. The image processing device is adapted to determine a first sub-image and a second sub-image on the capturing image, to compute relationship between a feature of the first sub-image and a corresponding feature of the second sub-image, and to compute a depth map about the capturing image via disparity of the foresaid relationship. The feature of the first sub-image is correlated with the corresponding feature of the second sub-image, and a scene of the first sub-image is at least partly overlapped with a scene of the second sub-image.

According to at least one claimed invention, a depth estimation method is applied to an image processing device having a receiving unit and a processing unit. The depth estimation method includes steps of receiving a capturing image by the receiving unit, determining a first sub-image and a second sub-image on the capturing image by the processing unit, computing relationship between a feature of the first sub-image and a corresponding feature of the second sub-image by the processing unit, and computing a depth map about the capturing image via disparity of the foresaid relationship by the processing unit, wherein the feature of the first sub-image is correlated with the corresponding feature of the second sub-image, and a scene of the first sub-image is at least partly overlapped with a scene of the second sub-image.

The virtual image generating unit of the depth estimation system is used to form a virtual position of the image capturing unit in space, the capturing image can be represented as containing patterns respectively captured by the physical image capturing unit and the virtual image capturing unit (which means the first sub-image and the second sub-image), the depth map is computed by disparity between the separated sub-images on the capturing image, so the depth estimation method can be executed by the single image capturing unit and the related virtual image generating unit. The first sub-image and the second sub-image on the same capturing image further can be made by other skills. Comparing to the prior art, the present invention computes the depth map by the single image captured by the single image capturing unit, can effectively economize product cost and simplify operational procedure.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a depth estimation system according to an embodiment of the present invention.

FIG. 2 is an appearance diagram of the depth estimation system and a tested object according to the embodiment of the present invention.

FIG. 3 is a simple diagram of the depth estimation system and the tested object according to the embodiment of the present invention.

FIG. 4 is a diagram of images processed by the depth estimation system according to the embodiment of the present invention.

FIG. 5 is a flow chart of a depth estimation method according to the embodiment of the present invention.

FIG. 6 to FIG. 8 respectively are diagrams of the depth estimation system and the tested object according to the different embodiments of the present invention.

FIG. 9 and FIG. 10 respectively are appearance diagrams of the depth estimation system in different operational modes according to the embodiment of the present invention.

FIG. 11 is an appearance diagram of the depth estimation system according to another embodiment of the present invention.

### DETAILED DESCRIPTION

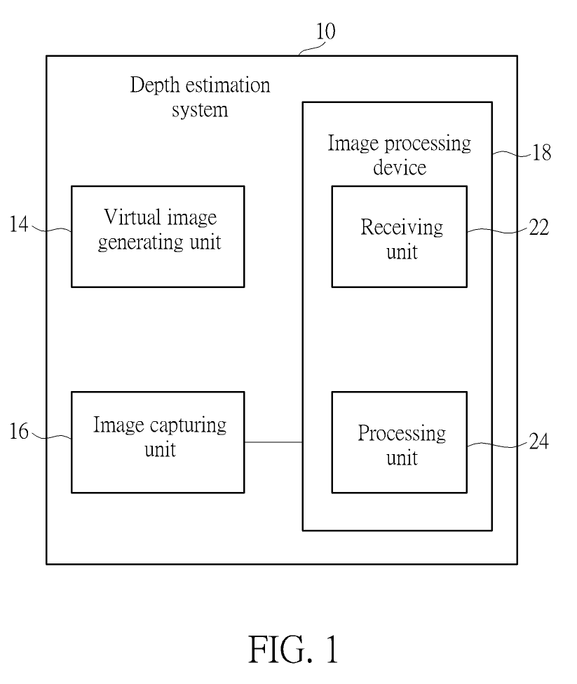

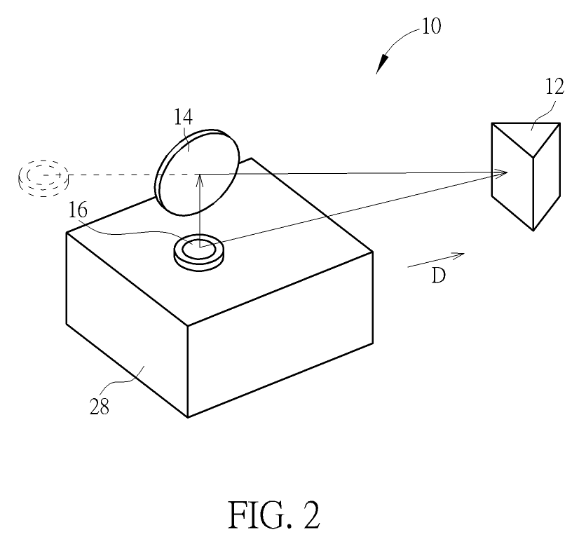

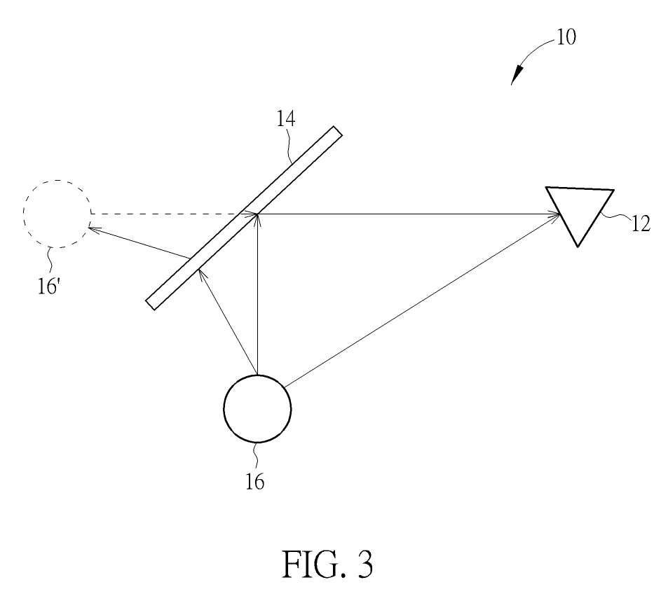

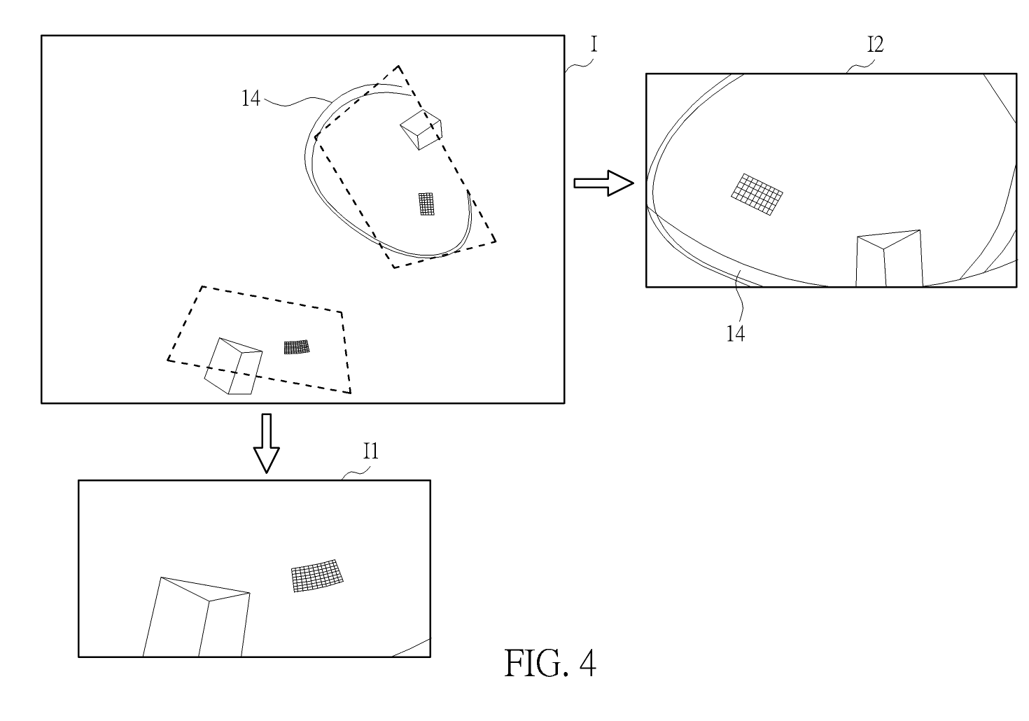

Please refer to FIG. 1 to FIG. 4. FIG. 1 is a block diagram of a depth estimation system 10 according to an embodiment of the present invention. FIG. 2 is an appearance diagram of the depth estimation system 10 and a tested object 12 according to the embodiment of the present invention. FIG. 3 is a simple diagram of the depth estimation system 10 and the tested object 12 according to the embodiment of the present invention. FIG. 4 is a diagram of images processed by the depth estimation system 10 according to the embodiment of the present invention. The depth estimation system 10 is assembled with any device to compute a depth image with regard to the tested object 12 in space by an individual image for detecting ambient environment or establishing navigation map. For example, the depth estimation system 10 can be applied to the mobile device, such that the depth estimation system 10 may be carried by the drone and the vehicle; the depth estimation system 10 further can be applied to the immobile device, such that the monitor may be disposed on a pedestal.

The depth estimation system 10 includes at least one virtual image generating unit 14, an image capturing unit 16 and an image processing device 18. The virtual image generating unit 14 and the image capturing unit 16 are disposed on a base 28, and the image capturing unit 16 is set adjacent by the virtual image generating unit 14 with predetermined displacement and rotation. A detective direction D of the depth estimation system 10 is designed according to an angle and/or an interval of the virtual image generating unit 14 relative to the image capturing unit 16; for instance, the virtual image generating unit 14 may face the detective direction D and the image capturing unit 16. The image capturing unit 16 may further include a wide angle optical component to provide wide visual field function. The wide angle optical component can be the fisheye lens or any other component to provide the wide angle view. Because of the wide visual field function of the image capturing unit 16, the detective direction D may be equal to hemispheric range above and/or around a detective arc surface of the image capturing unit 16. The tested object 12 located at the detective direction D (or within a detective region) can be photographed by the image capturing unit 16, the virtual image generating unit 14 is stayed within the visual field of the image capturing unit 16, so that the image capturing unit 16 can generate a capturing image I containing patterns about the virtual image generating unit 14 and the tested object 12.

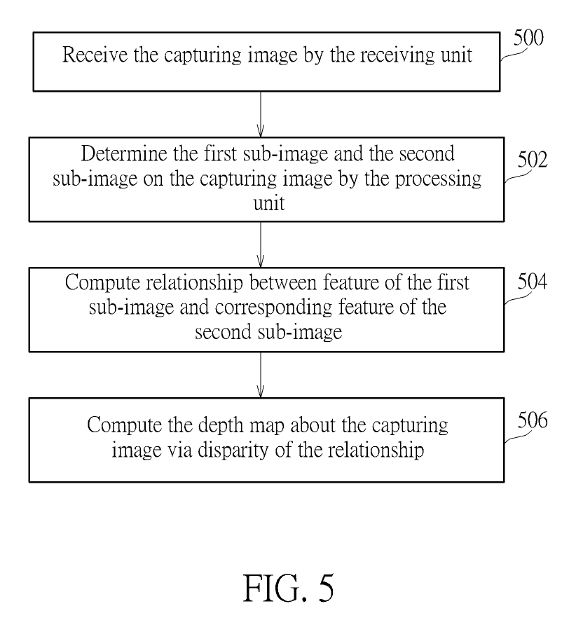

Please refer to FIG. 3 to FIG. 5. FIG. 5 is a flow chart of a depth estimation method according to the embodiment of the present invention. The image processing device 18 has a connection with the image capturing unit 16 through the receiving unit 22. The image processing device 18 can be a microchip, a controller, a processor or any similar units with related operating capability for executing the depth estimation method. While the capturing image I is produced, step 500 is firstably executed to receive the capturing image I by the receiving unit 22 of the image processing device 18. The receiving unit 22 can be any wire/wireless transmission module, such as an antenna. Then, step 502 is executed to determine a first sub-image I1 and a second sub-image I2 on the capturing image I by the processing unit 24 of the image processing device 18. The first sub-image I1 is a primary photo about the tested object 12, and the second sub-image I2 is a secondary photo formed by the virtual image generating unit 14, which means a scene of the first sub-image I1 is at least partly overlapped with a scene of the second sub-image I2 or the first sub-image I1 and the second sub-image I2 may have a similar scene (for example, the scene where the tested 12 is located). The angle and the interval of the virtual image generating unit 14 relative to the image capturing unit 16 are known, so that positions of the first sub-image I1 and a second sub-image I2 within the capturing image I can be determined accordingly. The tested object 12 is photographed to be a feature on the first sub-image I1 and the second sub-image I2, which means the said features of the first sub-image I1 and the second sub-image I2 are related to the identical tested object 12. The feature on the first sub-image I1 has parallax parameters different from parallax parameters of the feature on the second sub-image I2, and finally steps 504 and 506 are executed to compute relationship between the feature of the first sub-image I1 and the corresponding feature of the second sub-image I2, and to compute a depth map about the capturing image I via disparity of the foresaid relationship.

In the present invention, the first sub-image I1 is a real image corresponding to the tested object 12, the second sub-image I2 is a virtual image corresponding to the tested object 12 and generated by the virtual image generating unit 14; that is to say, the virtual image generating unit 14 can preferably be an optical reflector, such as a planar reflector, a convex reflector or a concave reflector, the second sub-image I2 is formed by reflection of the optical reflector, and the dotted mark 16′ is represented as a virtual position of the physical image capturing unit 16 through the virtual image generating unit 14. The second sub-image I2 further can be generated by another technical skill, any method capable of utilizing an image containing object patterns located on different regions (such as the said sub-image) of the image to compute the depth map of the object belongs to a scope of the depth estimation method in the present invention. The capturing image I captured by the image capturing unit 16 contains the real pattern (such as the first sub-image I1) and the reflective pattern (such as the second sub-image I2) of the tested object 12. A vision angle and a depth position (which are represented as the foresaid parallax parameters) of the tested object 12 on the first sub-image I1 are different from the vision angle and the depth position of the tested object 12 on the second sub-image I2. The second sub-image I2 can be a mirror image or any parallax image in accordance with the first sub-image. The first sub-image I1 and the second sub-image I2 are different and non-overlapped regions on the capturing image I preferably, as shown in FIG. 4.

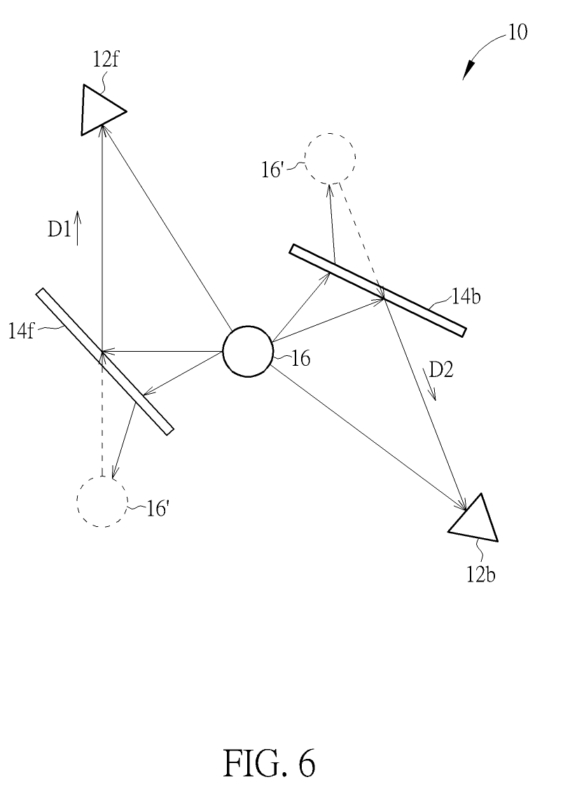

Please refer to FIG. 6 to FIG. 8. FIG. 6 to FIG. 8 respectively are diagrams of the depth estimation system 10 and the tested object 12 according to the different embodiments of the present invention. In the embodiment shown in FIG. 6, the depth estimation system 10 includes two virtual image generating units 14f and 14b set on different locations adjacent by the image capturing unit 16 or set facing different directions adjacent by the image capturing unit 16. The virtual image generating unit 14f and the virtual image generating unit 14b respectively face the detective direction D1 and the detective direction D2 different from each other; for example, the detective direction D1 can be forward and the detective direction D2 can be backward. The depth estimation system 10 is able to detect and compute the depth map about the tested object 12f and the tested object 12b merely by the single image capturing unit 16 and the virtual image generating unit 14f and the virtual image generating unit 14b. Light transmission paths between the tested object 12f and the image capturing unit 16 and between the tested object 12b and the image capturing unit 16 are not sheltered by the virtual image generating unit 14f and the virtual image generating unit 14b.

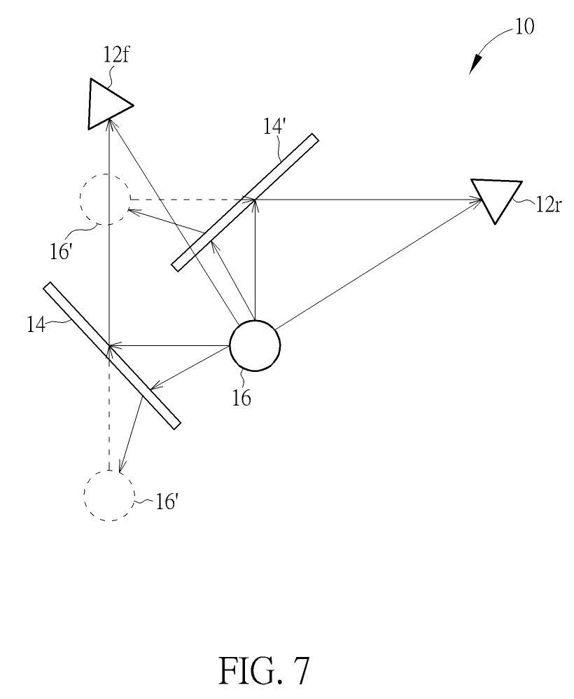

In the embodiment shown in FIG. 7, the virtual image generating unit 14′ can be an optical see-through reflector made of specific material with switchable reflecting function and see-through function, and a light transmission path between the image capturing unit 16 and the tested object 12f can be sheltered by the virtual image generating unit 14′ (the optical see-through reflector); the depth estimation system 10 can compute the depth map about the tested object 12f and the tested object 12r at the different time merely by the image capturing unit 16 and the virtual image generating units 14 and 14′.

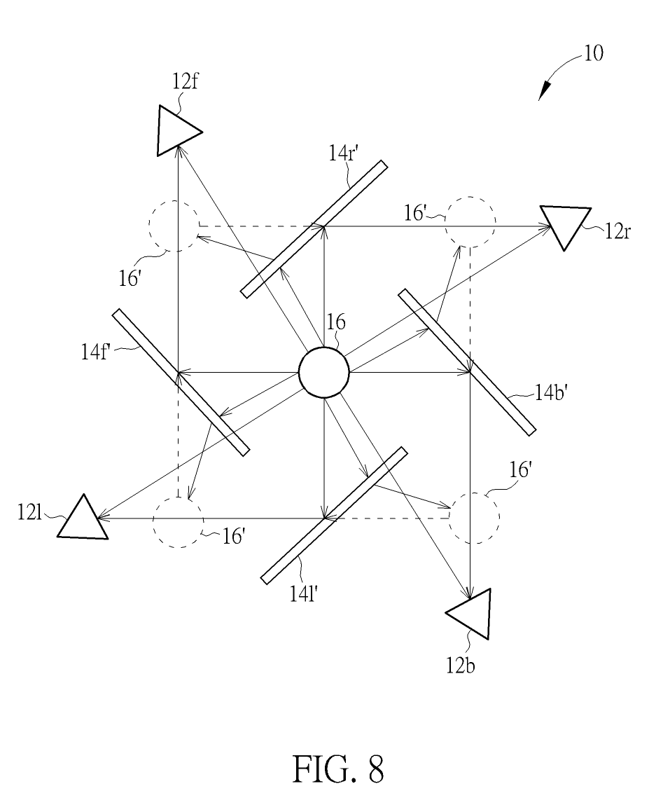

In the embodiment shown in FIG. 8, the depth estimation system 10 can compute the depth map about the tested object 12f, the tested object 12b at one time T1, and the tested object 12r and the tested object 121 at the other time T2 by the image capturing unit 16, the virtual image generating unit 14r′, the virtual image generating unit 141′, the virtual image generating unit 14f′ and the virtual image generating unit 14b′. Moreover, if the image capturing unit 16 can receive the energy from different light spectrum (e.g. visible light and infrared light) and the light spectrum returned back could be distinguished between the object 12f or 12b and object 12r or 121, then the system 10 could compute the depth map at the same time. For example, the object 12f is red, and the object 12r is green, then the system could compute the depth map in the front and right direction within the same capturing image I.

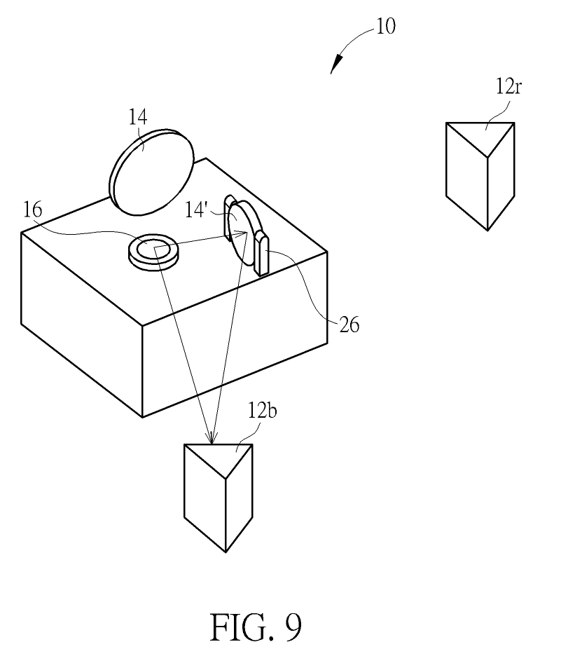

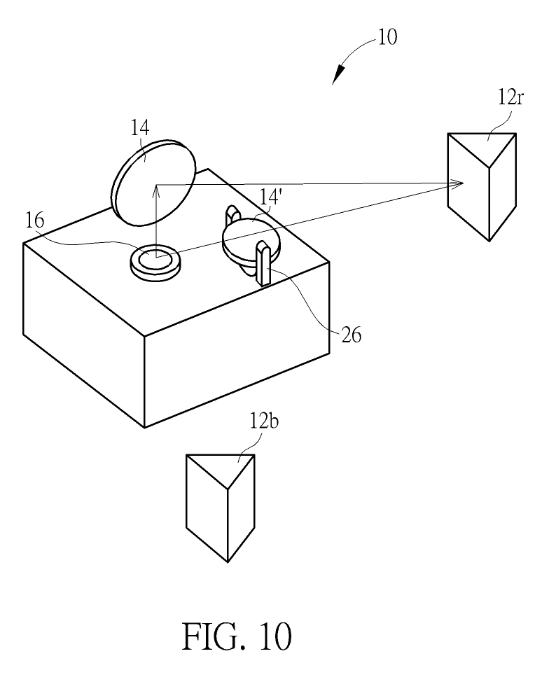

It should be mentioned that the embodiments shown in FIG. 7 and FIG. 8 preferably need an additional function to help the image capturing unit 16 captures the capturing image I through the virtual image generating unit 14′. Please refer to FIG. 9 and FIG. 10. FIG. 9 and FIG. 10 respectively are appearance diagrams of the depth estimation system 10 in different operational modes according to the embodiment of the present invention. The depth estimation system 10 may further include a switching mechanical device 26 utilized to switch a rotary angle of the virtual image generating unit 14′ relative to the image capturing unit 16. For example, the switching mechanical device 26 may rotate an axle passing through the virtual image generating unit 14′ to change the said rotary angle. Because the virtual image generating unit 14′ stands on a light transmission path between the image capturing unit 16 and the tested object 12r, the switching mechanical device 26 rotates the virtual image generating unit 14′ from position shown in FIG. 9 to position shown in FIG. 10, so the image capturing unit 16 is able to capture the capturing image I about the tested object 12r via reflection of the virtual image generating unit 14. While the switching mechanical device 26 recovers the virtual image generating unit 14′ to the position shown in FIG. 9, the image capturing unit 16 captures the capturing image I about the tested object 12b via reflection of the virtual image generating unit 14′.

The virtual image generating unit 14′ further can be made of the specific material mentioned as above, the image processing device 18 can input an electrical signal to vary material property (such like molecular arrangement) of the virtual image generating unit 14′ to switch the reflecting function and the see-through function, so as to allow the image capturing unit 16 for capturing the tested object 12r by passing through the virtual image generating unit 14′, or capturing the tested object 12b by reflection of the virtual image generating unit 14′. Therefore, the switching mechanical device 26 utilized to rotate the virtual image generating unit 14′ and the virtual image generating unit 14′ capable of varying the material property can be applied to the embodiments shown in FIG. 7 and FIG. 8. The switching mechanical device 26 further can rotate the virtual image generating unit 14′ by a vertical axle, instead of rotation relative to the horizontal axle shown in FIG. 9 and FIG. 10. Any additional function for switching the reflecting function and the see-through function belongs to a scope of the virtual image generating unit in the present invention.

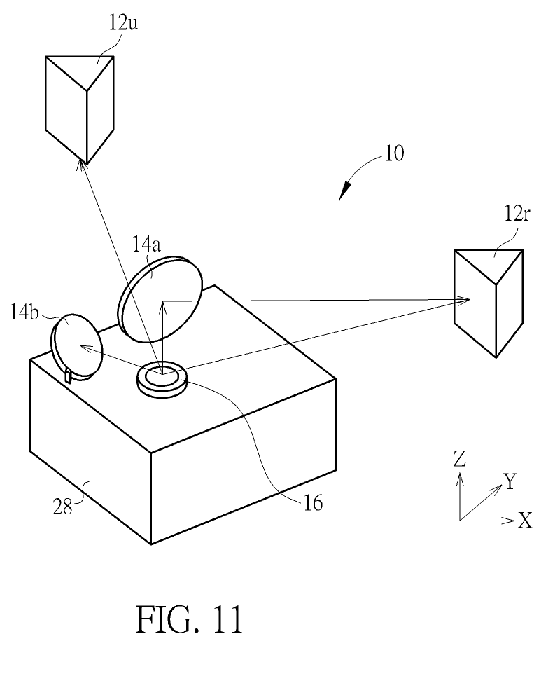

Please refer to FIG. 11. FIG. 11 is an appearance diagram of the depth estimation system 10 according to another embodiment of the present invention. The depth estimation system 10 may have several virtual image generating units 14a and 14b respectively set on different inclined angles. The virtual image generating unit 14a perpendicularly stands on the base 28 to reflect the optical signal along the XY plane for detecting the tested object 12r. The virtual image generating unit 14b is inclined on the base 28 to reflect the optical signal along the Z direction for detecting the tested object 12u. The depth estimation system 10 may dispose the virtual image generating units 14a and 14b around the image capturing unit 16 to detect the tested object on different level height (which is compared to the base 28); or the depth estimation system 10 may assemble the switching mechanical device 26 with the single virtual image generating unit (not shown in figures), and the single virtual image generating unit can be rotated to simulate conditions of the virtual image generating units 14a and 14b.

In conclusion, while the depth estimation system acquires the capturing image, the first sub-image and the second sub-image are defined and calibrated by parameters (such as an image center, a distortion coefficient, skew factor and so on), and feature relationship between the first sub-image and the second sub-image is compared with calibration of parameters of the fixed image capturing unit and extrinsic parameter of the virtual image generating unit, such like rotation and/or translation of 6DOF (Degree of freedom), so as to accurately compute the depth map about the capturing image and the tested object. The image capturing unit may optionally utilize the wide angle optical component to vary the field of view, the wide angle optical component can be the convex reflector to generate the large field of view with small lens, or can be the concave reflector to capture the high resolution image surrounding the center field of view.

The virtual image generating unit of the depth estimation system is used to form a virtual position of the image capturing unit in space, the capturing image can be represented as containing patterns respectively captured by the physical image capturing unit and the virtual image capturing unit (which means the first sub-image and the second sub-image), the depth map is computed by disparity between the separated sub-images on the capturing image, so the depth estimation method can be executed by the single image capturing unit and the related virtual image generating unit. The first sub-image and the second sub-image on the same capturing image further can be made by other skills. Comparing to the prior art, the present invention computes the depth map by the single image captured by the single image capturing unit, can effectively economize product cost and simplify operational procedure.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing device, comprising:
a receiving unit adapted to receive a capturing image; and
a processing unit electrically connected with the receiving unit to determine a first sub-image and a second sub-image on the capturing image, to compute relationship between a feature of the first sub-image and a corresponding feature of the second sub-image, and to compute a depth map about the capturing image via disparity of the foresaid relationship;
wherein the feature of the first sub-image is correlated with the corresponding feature of the second sub-image, and a scene of the first sub-image is at least partly overlapped with a scene of the second sub-image.

2. The image processing device of claim 1, wherein first sub-image and the second sub-image are different and non-overlapped regions on the capturing image.

3. The image processing device of claim 1, wherein a vision angle of the feature on the first sub-image is different from a vision angle of the feature on the second sub-image.

4. The image processing device of claim 1, wherein a depth position of the feature on the first sub-image is different from a depth position of the feature on the second sub-image.

5. The image processing device of claim 1, wherein the second sub-image is a mirror image in accordance with the first sub-image.

6. The image processing device of claim 1, wherein the second sub-image is a virtual image reflected by an optical reflector or an optical see-through reflector.

7. A depth estimation system, comprising:
at least one virtual image generating unit set on a location facing a detective direction of the depth estimation system;
an image capturing unit disposed by the virtual image generating unit and having a wide visual field function, the image capturing unit generating a capturing image containing the virtual image generating unit via the wide visual field function; and
an image processing device electrically connected to the image capturing unit, the image processing device being adapted to determine a first sub-image and a second sub-image on the capturing image, to compute relationship between a feature of the first sub-image and a corresponding feature of the second sub-image, and to compute a depth map about the capturing image via disparity of the foresaid relationship;
wherein the feature of the first sub-image is correlated with the corresponding feature of the second sub-image, and a scene of the first sub-image is at least partly overlapped with a scene of the second sub-image.

8. The depth estimation system of claim 7, wherein the first sub-image is a real image generated by the image capturing unit, and the second sub-image is a virtual image correlated with the real image and generated by the virtual image generating unit.

9. The depth estimation system of claim 7, wherein the image capturing unit comprises a wide angle optical component to provide the wide visual field function.

10. The depth estimation system of claim 7, wherein the image capturing unit is disposed by the virtual image generating unit with predetermined displacement and rotation.

11. The depth estimation system of claim 7, wherein the virtual image generating unit is a planar reflector, a convex reflector or a concave reflector.

12. The depth estimation system of claim 7, further comprising:
a switching mechanical device adapted to switch a rotary angle of the virtual image generating unit relative to the image capturing unit.

13. The depth estimation system of claim 7, wherein the virtual image generating unit is made of specific material with reflecting function and see-through function switched by an electrical signal.

14. The depth estimation system of claim 7, wherein the depth estimation system comprises another virtual image generating unit set on another location adjacent by the image capturing unit to face another detective direction of the depth estimation system.

15. The depth estimation system of claim 7, wherein first sub-image and the second sub-image are different and non-overlapped regions on the capturing image.

16. The depth estimation system of claim 7, wherein the second sub-image is a mirror image in accordance with the first sub-image.

17. The depth estimation system of claim 7, wherein a vision angle of the feature on the first sub-image is different from a vision angle of the feature on the second sub-image.

18. The depth estimation system of claim 7, wherein a depth position of the feature on the first sub-image is different from a depth position of the feature on the second sub-image.

19. The depth estimation system of claim 7, wherein the second sub-image is a virtual image reflected by an optical reflector or an optical see-through reflector.

20. A depth estimation method applied to an image processing device having a receiving unit and a processing unit, the depth estimation method comprising:
receiving a capturing image by the receiving unit;
determining a first sub-image and a second sub-image on the capturing image by the processing unit;
computing relationship between a feature of the first sub-image and a corresponding feature of the second sub-image by the processing unit; and
computing a depth map about the capturing image via disparity of the foresaid relationship by the processing unit, wherein the feature of the first sub-image is correlated with the corresponding feature of the second sub-image, and a scene of the first sub-image is at least partly overlapped with a scene of the second sub-image.
